(19) United States
(12) Patent Application Publication
(10) Pub. No.: US 2009/0178140 A1
(43) Pub. Date: Jul. 9, 2009

(54) NETWORK INTRUSION DETECTION SYSTEM

(75) Inventors: Cang-Mou Cao, Tianjin (CN); Chuen-Mei Ma, Tianjin (CN); Cong Meng, Tianjin (CN); Tom Chen, Taipei (TW); Win-Harn Liu, Taipei (TW)

Correspondence Address: APEX JURIS, PLLC, 12733 LAKE CITY WAY NORTHEAST, SEATTLE, WA, 98125, US

(73) Assignee: INVENTEC CORPORATION, Taipei (TW)

(21) Appl. No.: 11/971,370

(22) Filed: Jan. 9, 2008

(51) Int. Cl. G06F 21/20

(52) U.S. Cl. 726/23

(57) ABSTRACT

A network intrusion detection system (IDS) is built at an important network node and used to detect and monitor network packets. The network intrusion detection system includes a network card and a system core processor. When receiving a network packet, a micro-processor of the network card performs a packet decode procedure and a packet preprocess procedure, thereby verifying a type and a source address of the packet in advance and converting the packet into an IDS format packet. Afterwards, the system core processor determines whether the packet is an intrusion packet. Since the computation of the packet decode procedure and the packet pre-process procedure is handled by the network card, the network intrusion detection system will not lose packets due to too heavy computation burden, thereby greatly improving the accuracy of the network intrusion detection system.

### BACKGROUND OF THE INVENTION

1. Field of Invention

The present invention relates to an intrusion detection system, and more particularly to an intrusion detection system having a network card capable of executing a packet decode procedure and a packet pre-process procedure.

2. Related Art

Usually, in most of network security solutions, antivirus softwares and firewalls are used to achieve the purpose of basic network security and protection. The antivirus softwares are used to protect computer systems against viruses and the firewalls are used to protect private data from stealing. Although most of malicious intrusions may be prevented from getting into the computer systems by firewalls and antivirus softwares, some hackers are still able to penetrate the firewalls to get access to the computer systems. Then, a network intrusion detection system (NIDS) technology is developed to become an important technology for protecting data in computer systems from stealing or preventing malicious damages to the computers. The intrusion detection system (IDS) acts with the firewalls to efficiently prevent malicious intrusion from the extra-net or intra-net. The intrusion detection system (IDS) mainly monitors and analyzes the network activities of a computer system, discovers the unauthorized or abnormal network packet activities in the system through analyzing all the received network packets, sends an alert about the abnormal access actions once the computer is intruded, and records statistical analysis results in a report. Generally speaking, the network intrusion detection system may be a computer/server built at an important Internet node, e.g. the rear end of a boundary router in the intra-net or the front end of an important (protected) server/computer mainframe, and may send alert signals once detecting malicious attacks or suspicious link activities, thereby blocking or filtering attacks caused by the malicious link and protecting the intra-net against the attacks to cause data stealing and data damage. The main detection methods of the network intrusion detection may be signature based detection, behavioral anomaly detection, and protocol anomaly detection. The server of the network intrusion detection system inspects network link states and the contents of the transmitted packets flowing through the server of the network intrusion detection system, and when discovering a network attack event or an abnormal event in consistency with that defined by the administrator of the network intrusion detection system, sends an alert to inform the administrator of the network intrusion detection system to defense or further record the abnormal event in a program or a log file.

The current network intrusion detection technology may be classified into two types, i.e., network-based intrusion detection system and mainframe-based intrusion detection system. In the network-based network intrusion detection system, the mainframe of the network intrusion detection system is placed at an important endpoint in a network segment, so as to carry out the characteristic analysis on each data packet or suspicious packet types flowing through the mainframe of the network intrusion detection. The mainframe-based network intrusion detection system is mainly used to analyze and determine the login file of a mainframe or a system. However, the network intrusion detection systems in spite of their types will consume certain system resources when carrying out the intrusion detection. The network intrusion detection system analyzes the types of the packets and even parses the contents of the packets. Therefore, in the high-speed network or the network with heavy traffic, such as ultra-high-speed Gigabit Ethernet, the intrusion attacks may be more complicated or the virus transmission may be at a high speed, but the network intrusion detection system is impossible to detect the network intrusion attacks in real time due to its poor response capability.

### SUMMARY OF THE INVENTION

In view of the problem that the response capability of the network intrusion detection system cannot keep up with a network environment with heavy traffic, the present invention is directed to provide a network intrusion detection system, in which a microprocessor capable of executing a packet decode procedure and a packet pre-process procedure is added on a network card so as to shoulder a part of the workload of a system core processor of a network intrusion detection system.

In order to achieve the aforementioned objectives, in the present invention, the network intrusion detection system is built at an important network node to detect and monitor network packets. The network intrusion detection system includes a network card and a system core processor. The network card receives multiple network packets. A memory and a microprocessor are disposed on the network card. The memory stores a packet decode procedure and a packet pre-process procedure, and temporarily stores the received network packets. The microprocessor is used to execute the packet decode procedure to parse the received network packets, and then to execute the packet pre-process procedure to analyze the parsing results, so as to generate multiple IDS format packets. The system core processor reads the IDS format packets, and determines whether the IDS format packets are normal formats/contents based on an IDS rule table, thereby determining whether the network has abnormal phenomena. If the network has abnormal phenomena, an anomaly alert report is sent to inform that the network is under intrusion.

In the network intrusion detection system according to the preferred embodiment of the present invention, the packet decode procedure includes the following steps. First, a netfilter is called to capture the packets flowing through the network card. The source addresses, destination addresses, and network communication protocol types of the packets are parsed. Afterwards, the parsing results of the packets are recorded in a network-flow info table. The packet decode procedure may respectively parse different network communication protocols by the use of multiple threads.

In the network intrusion detection system according to the preferred embodiment of the present invention, the packet pre-process procedure includes the following steps. First, multiple pre-processors are loaded. The network-flow info table is read, and the IDS format packets are generated based on the IDS rule table and the network-flow info table. An IDS rule may be added to or deleted from the IDS rule table through an user interface. In addition, through the user interface, a new pre-processor may be added or one of the loaded pre-processors may be removed.

In the network intrusion detection system according to the preferred embodiment of the present invention, an anomaly alert report when generated may be sent through an intrusion detection record file, an intrusion detection voice prompt, or an intrusion detection text prompt.

Based on the above, in the present invention, a microprocessor capable of executing a packet decode procedure and a packet pre-process procedure is added to shoulder a part of the workload of the system core processor. The microprocessor of the network card performs the pre-processing on the network packet, and the system core processor just determines whether a packet is abnormal. Since the steps of parsing the packet and determining whether a packet is abnormal may be performed at the same time, the network intrusion detection system may process at a higher speed, so as to meet the processing requirements of a heavy packet flow in the high-speed network environment and avoid losing packets which reduces the accuracy of the network intrusion detection.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a network intrusion detection system in a network topology according to a preferred embodiment of the present invention;

FIG. 2 is a schematic architectural view of the network intrusion detection system according to a preferred embodiment of the present invention;

FIG. 3 is a schematic view of adding or deleting a pre-processor by the use of an user interface according to an embodiment of the present invention; and

FIG. 4 is a schematic view of adding or deleting an IDS rule by the use of an user interface according to an embodiment of the present invention.

### DETAILED DESCRIPTION OF THE INVENTION

The objectives of the present invention and the provided network intrusion detection system will be illustrated in detail in the following preferred embodiments. However, the concept of the present invention may also be used in other scopes. The following embodiments are merely to illustrate the objectives and implementation methods of the present invention, and are not intended to limit the scope.

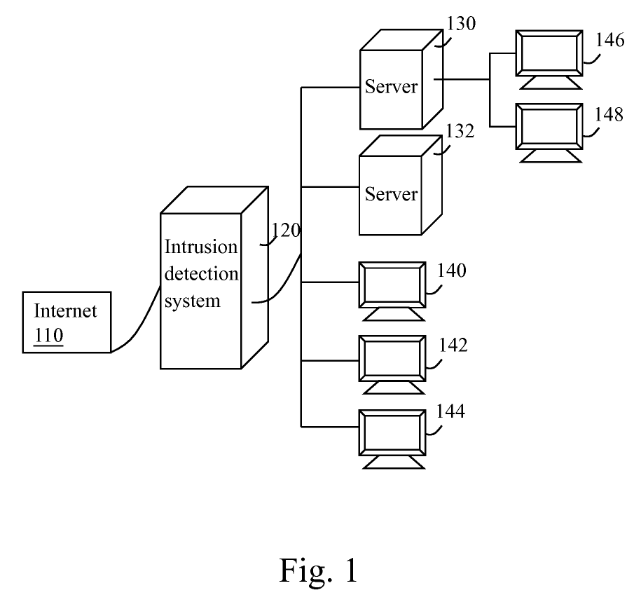

FIG. 1 is a schematic view of the network intrusion detection system in a network topology according to a preferred embodiment of the present invention. Referring to FIG. 1, a network intrusion detection system 120 is usually built at an important network node in the intra-net, so as to detect and monitor the network packets, and then to discover abnormal network activities and filter them, thereby protecting the data in each mainframe in the intra-net from stealing or protecting the mainframe systems against the malicious damages. In the preferred embodiment, the network intrusion detection system 120 is built at a rear end of a boundary server (not shown) in the intra-net, and then connected to Internet 110, thereby protecting servers (130, 132) or computer mainframes (140, 142, 144, 146, 148) in the intra-net. In some embodiments, the network intrusion detection system 120 may also be built at any important node in the intra-net, for example, at a front end of the server 130, so as to protect the server 130 and the computer mainframes (146, 148) at the rear end of the server 130, and send an alert signal in real time to inform a network administrator to eliminate the malicious network intrusion activities (for example, reject the packets of the malicious intruders) as soon as detecting them.

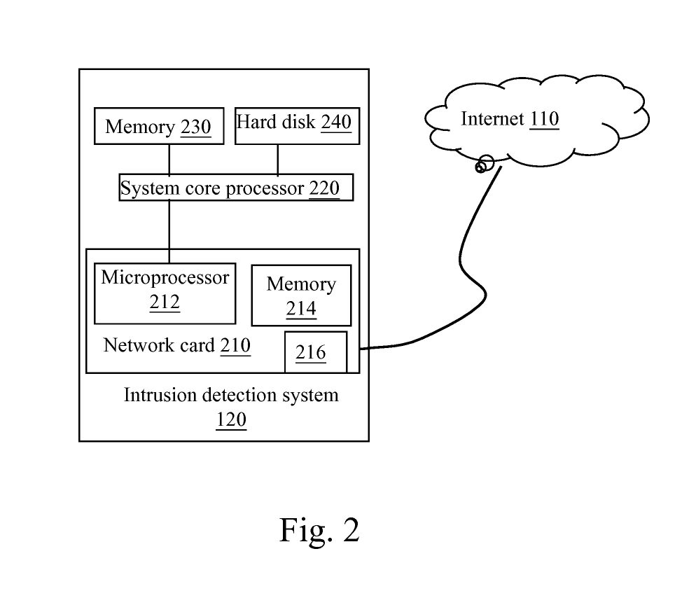

Then, the architecture of the network intrusion detection system of the present invention is described. FIG. 2 is a schematic view of the architecture of the network intrusion detection system according to a preferred embodiment of the present invention. Referring to FIG. 2, the network intrusion detection system 120 is connected to the Internet 110 through a connection port 216 on a network card 210. The network intrusion detection system 120 includes two parts, namely the network card 210 for receiving the network packets and a system core processor 220 of the system mainframe. The two parts are respectively used to perform the packet pre-processing action of the network intrusion detection and the action of determining whether the packets are abnormal. The network card 210 includes a memory 214, which stores a network packet decode procedure and a packet pre-process procedure, and the other memory space is used to temporarily store the received network packets. The network card 210 further includes a microprocessor 212, which performs the packet decode procedure to parse the network packets temporarily stored in the memory 214, and performs the packet pre-process procedure, so as to analyze the parsing results of the packet decode procedure and further convert the parsed packets into the IDS format packets. The so-called IDS format packets include source addresses, destination addresses, connection ports, used network communication protocols, and particular fields such as symbols carried by the packet contents, which are used for the network intrusion detection system to make determination. The network intrusion detection system may parse the headers of the packets without consuming additional computation resources, and may read the fields in the packets and determine whether the packets are abnormal. The system core processor 220 is used to determine whether the IDS format packets are abnormal. The system core processor 220 first receives/reads the IDS format packets processed by the network card, reads the IDS rule table of a system memory 230 or a hard disk 240, and determines whether the IDS format packets are abnormal based on the IDS rule table. If one IDS format packet is determined to be abnormal, the link suggested by the source address of the abnormal packet is deemed as an abnormal link, and an anomaly alert report is sent to inform a network administrator of the abnormal phenomenon of the current network or the current network under intrusion.

The packet decode procedure includes the following steps. First, a netfilter is called to capture the packets flowing through the network card 210. Subsequently, the header information such as source addresses, destination addresses, and network communication protocol types of the packets is parsed, and the contents of the packets are inspected to determine whether carry particular symbols or are deemed as malicious data such as viruses or Trojan horses. After these network packets have been parsed, the parsing results are recorded in a network-flow info table and the network-flow info table is temporarily stored in the memory 214 of the network card 210. In addition, when the microprocessor 212 of the network card 210 executes the packet decode procedure, the microprocessor 212 respectively processes data of different communication protocols through a plurality of threads, thereby enhancing the speed of the parsing packets. The packet pre-process procedure is used to set the network intrusion detection system, which includes loading multiple pre-processors in advance, reading the network-flow info table stored in the memory 214 of the network card 210 and generating the corresponding IDS format packets based on the IDS rule table and the network-flow info table.

Each intrusion action has its special mode. For example, Denial of Service (DOS) means that an attacker after intruding into a server controls a large amount of packets transmitted by the intruded server in a specific time period, thereby attempting to prevent the server from providing normal link services. Such intrusion action mode is defined as the intrusion rules and gathered to form an IDS rule table. If the information carried by the received packet meets the conditions listed in the IDS rule table, it is considered that the intrusion action is confirmed. Meanwhile, it is determined that the link established by the source addresses of the packets or the services or connection ports to be accessed become abnormal, and an alert report is sent to inform the network administrator to make an appropriate response to the intrusion action.

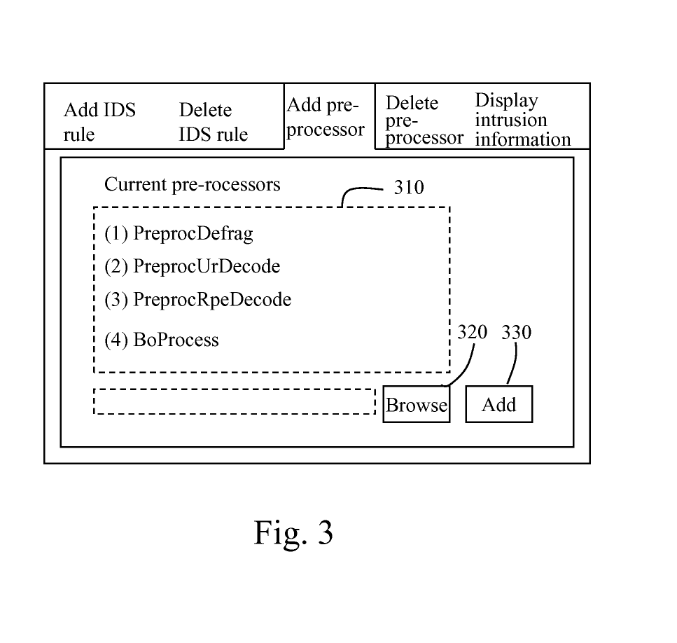

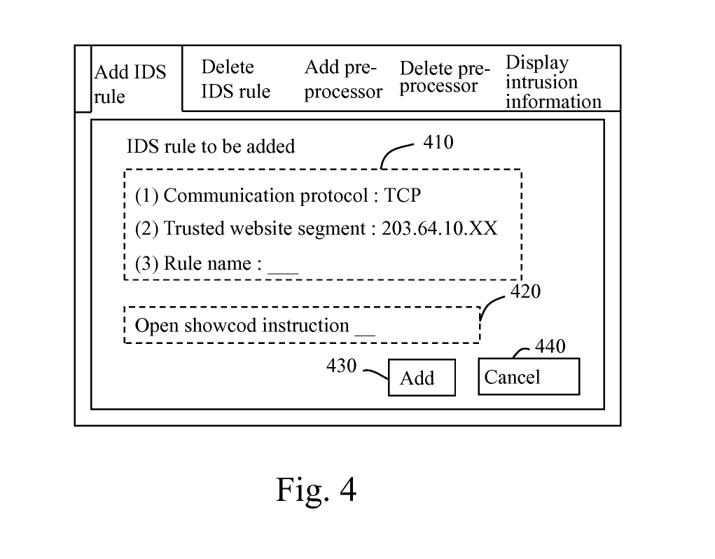

FIG. 3 is a schematic view of adding or deleting a pre-processor by the use of an user interface according to an embodiment of the present invention. Referring to FIG. 3, an user can add the pre-processor function by the use of the user interface, and at this time, the system core processor captures the types of the loaded pre-processors from the memory on the network card, and then displays the types of the loaded pre-processors (such as PreprocDefrag pre-processors and BoProcess pre-processors) on a display window 310 in FIG. 3. The user may select a button “Browse” 320 to capture the pre-processor stored in the IDS system, and after selecting the pre-processor to be added, select a functional button “Add” 330 so as to load the pre-processor into the network card. In addition, the user may also add a decode rule of network packets through this user interface. FIG. 4 is a schematic view of adding or deleting an IDS rule by the use of an user interface according to an embodiment of the present invention. After the user selects an option “Add IDS rule,” the new IDS rule may be listed in an input window 420. The new IDS rule may be displayed with an adjustable size in the display window 410. In order to add the IDS rule, click a button “Add” 430. Otherwise, in order to give up the establishment of the rule, click a button “Cancel” 440. When the button “Add” 430 is clicked, the system core processor will immediately write the data of the added IDS rule into the IDS rule table, and determines whether the network packets are normal/abnormal packets based on the new IDS rule table. In some embodiments, the user interface may further be used to add or delete the packet decode rule. In this embodiment, the packet decode rule is, for example, recorded in the IDS rule table or a packet decode rule table, which will not be limited herein.

In order to clarify the intrusion detection system (IDS) provided by the present invention, an attacking manner named “NT IIS Showcode ASP” will be illustrated, which gets illegal access rights through a structural website. Such attacking manner is a kind of network intrusion which sends a URL link request to a network server, so as to read the files in the server illegally (without permission), for example, sending a URL link “http://attack.host/msadc/Samples/SELECTOR/showcode.asp?source=/msadc/Samples/ . . . / . . . / . . . / . . . / . . . /boot.ini.” When this network packet of this attacking manner is received, firstly, the microprocessor on the network card parses the source address of the packet and the accessed connection port, and parses the control code “/selector/showcode.asp” contained in the content of the data segment of the packet. After the packet is parsed, the IDS format packet including the source address, the destination address, the connection port, and the carried special data segment content (the specific control code carried by the packet is recorded in the field of the special data segment content) of the packet is generated. The system core processor reads that the packet type is the TCP and includes a specific control code, and further determines whether the control code is showcode.asp. If it is the showcode.asp, such link is determined whether to be the link sent by a trusted segment (i.e., a default network address segment). If it is not the link sent by the trusted segment, the link is determined to be abnormal and an anomaly alert report will be sent to inform the network administrator to make further conformation and record the relevant information about the abnormal link in the alert log file “syslog.txt.”

What is claimed is:

1. A network intrusion detection system, configured at an important network node and to detect and monitor network packets, comprising:
a network card, receiving a plurality of network packets, the network card comprising:
a memory, storing a packet decode procedure and a packet pre-process procedure, and temporarily stores the network packets; and
a microprocessor, executing the packet decode procedure to parse the network packets and the packet pre-process procedure to analyze parsing results of the network packets, so as to generate a plurality of IDS format packets; and
a system core processor, reading the IDS format packets and determining whether the IDS format packets are abnormal based on an IDS rule table, and if abnormal, informing that the network is under intrusion by sending an anomaly alert report.

2. The network intrusion detection system as claimed in claim 1, wherein the packet decode procedure comprises:
calling a netfilter to capture the packets flowing through the network card;
parsing source addresses, destination addresses, and network communication protocol types of the packets; and
recording parsing results of the packets in a network-flow info table.

3. The network intrusion detection system as claimed in claim 2, wherein the packet pre-process procedure comprises:
loading a plurality of pre-processors; and
reading the network-flow info table and generating the IDS format packets based on the IDS rule table and the network-flow info table.

4. The network intrusion detection system as claimed in claim 1, wherein an IDS rule is added to or deleted from the IDS rule table through an user interface.

5. The network intrusion detection system as claimed in claim 4, wherein through the user interface, a new pre-processor is added or one of the loaded pre-processors is deleted.

6. The network intrusion detection system as claimed in claim 1, wherein the anomaly alert report is one selected from an intrusion detection record file, an intrusion detection voice prompt, or an intrusion detection text prompt.

7. The network intrusion detection system as claimed in claim 1, wherein the packet decode procedure further comprises respectively processing different network communication protocols through a plurality of threads.
